(19) United States
(12) Patent Application Publication
(10) Pub. No.: US 2014/0272406 A1
(43) Pub. Date: Sep. 18, 2014

(54) PROTECTION FILM FOR DISPLAY AND MANUFACTURING METHOD THEREOF

(71) Applicants: Won Keun Yoo, Gyeonggi-do (KR); SEJONG ADVANCED TECHNOLOGY CO., LTD., Gyeonggi-do (KR)

(72) Inventors: Won Keun Yoo, Gyeonggi-do (KR); Hyun Dong Kim, Gyeonggi-do (KR); Sung Ho Park, Gyeonggi-do (KR)

(73) Assignees: SEJONG ADVANCED TECHNOLOGY CO., LTD., Gyeonggi-do (KR); Won Keun Yoo, Gyeonggi-do (KR)

(21) Appl. No.: 14/353,001

(22) PCT Filed: Oct. 19, 2012
(86) PCT No.: PCT/KR2012/008582

§ 371 Date: Apr. 18, 2014

(30) Foreign Application Priority Data
Oct. 20, 2011 (KR) 10-2011-0107483

(51) Int. Cl. G02F 1/1333

(52) U.S. Cl. CPC G02F 1/1333
USPC 428/344; 156/182; 428/354

(57) ABSTRACT

The invention relates to protection film for a display and its manufacturing method to protect a display by mounting on the front surface of a display, and protection film for a display of the invention comprises tempered glass film(110), wherein the one side of flat surface is coated with antifoulant coating layer(111); anti-spattering layer(120) which is optically transparent and bonded to the underneath of the said tempered glass film(110) by first optical adhesive layer(121); and the second optical adhesive layer(122) which can be bonded to the surface of a display(1) by being bonded to the underneath of the anti-spattering layer(120), and forms functional thin layer with functionality on the bottom surface of tempered glass film or anti-spattering film, provides protection film of highly transparent thin layer by complete attachment between each film unit, wherein no air space occurs, prevents error of optical sensor and decrease of touch sensitivity in electronic equipment with touch input means, especially, provides means to block hazardous electromagnetic waves by preparing conductive metal layer as functional thin layer, and facilitates cleaning by detachability from display screen at multiple time.

### TECHNICAL FIELD

The invention relates to protection film for display and its manufacturing method and especially relates to protection film for display which is mounted on a display front, and protects display and blocks hazardous electromagnetic waves, but is thin with high transparency and manufacturing method thereof

### BACKGROUND ART

In general, protection film is mounted on a display front of electronic devices such as TV, monitor, mobile phone, PDA, navigation to protect display from stains of fingerprint or foreign substance or extra pollution.

For a conventional protection film adhesive is applied on display mounting surface for easy desorption, and acrylic adhesives are widely used for adhesive. However, bubbles can occur very often when protection film coated with acrylic adhesives is attached to the display surface by unskilled worker. And with desorption and attachment repeated multiple times, adhesiveness is decreased, thus re-attachment may not be possible and reconstruction may be needed.

For example, unexamined patent publication 10-2005-0093946(publication date: 2005.09.23) offers LCD protection film which prepares a plurality of protection sheet which protect adhesive surface of transparent film, and suggests unskilled worker easily construct protection film. However, it is not easy to remove an attached protection film.

FIG. 1 shows the cross-sectional structure of protection film according to other conventional technologies, protection film(20) coated with an adhesive(10) along the edge of back side is attached to a display(1) to protect a display(1), and double sided tape can be used for an adhesive.

However, these conventional protection films are manufactured by processing resin-series integrally, and automated manufacturing process is complicating, and manufacturing yield is low.

Also, for conventional protection film, display (1) and protection film(20) require an adhesive such as double-sided tape along the edge, thus air space(11) is formed by the level difference between the surface of a display(1) and the center part of protection film, and this air space(11) can cause stain on a display by slag of protection film or moisture intrusion which makes upper layer and lower layer stick to each other. Especially this shape can often occur in case the air layer is approximately as thin as within 0.05-0.1 mm.

### DISCLOSURE

### Technical Problem

The invention is to solve the problems of conventional technologies, to provide thin protection film of high transparency which can have various functions by including especially functional thin layer such as conductive metal layer blocking hazardous electromagnetic waves and which can be detached and attached multiple times repeatedly.

Also, the invention provides manufacturing method of protection film for a display which can improve manufacturing yield in manufacturing protection film for a display, and increase productivity.

### Technical Solution

A protection film for a display according to the present invention in order to achieve the purpose above can be achieved by an antifouling coating layer coated on one side of it, and a tempered glass film with a functional thin film layer on the other side of it; an optically transparent anti-spattering layer bonded to the said functional thin layer with the first optical adhesive layer therebetween; and the second optical adhesive layer by which the anti-spattering layer is bonded to the display surface.

Also, a protection film for a display according to a different view of the invention in order to achieve the purpose above can be achieved by a tempered glass film with an antifouling coating layer coated on one side of it; an optically transparent anti-spattering layer bonded to the other side of the said tempered glass film with the first optical adhesive layer therebetween; a functional thin layer bonded to one side of the said anti-spattering layer with the second optical adhesive layer therebetween; and the third optical adhesive layer by which the other side of the anti-spattering layer is bonded to the display surface.

According to the invention preferably, the first optical adhesive layer or the second optical adhesive layer is characterized by acrylic or silicon-series, or the said second optical adhesive layer or the third optical adhesive layer is characterized by silicon or urethane-series.

According to the invention preferably, either the said first and second optical adhesive layer or the said second and third optical adhesive layer is characterized by including antimicrobial.

According to the invention preferably, the said anti-spattering layer is characterized by PET film with high transparency.

According to the invention preferably, the said functional thin layer is characterized by conductive metal layer to block electromagnetic waves.

Next, a method of manufacturing a protection film for a display according to the invention in order to achieve the said purpose can be achieved by the following steps, comprising the first step of manufacturing a tempered glass film unit by coating an antifouling coating layer one side of the tempered glass and forming a functional thin film layer on the other side of it; the second step of applying optically transparent optical adhesive on both sides of a highly transparent PET film to make an anti-spattering film unit; the third step of bonding the tempered glass film unit and the anti-spattering film unit produced from the first and second steps, respectively.

Also, a method of manufacturing a protection film for a display according to a different view of the invention in order to achieve the purpose above can be achieved by the following steps, comprising the first step of manufacturing a tempered glass film unit by coating an antifouling coating layer one side of the tempered glass; the second step of applying optically transparent optical adhesive on both sides of a highly transparent PET film to make an anti-spattering film unit; the third step of applying optically transparent optical adhesive on a functional thin layer to make a functional thin layer film unit; and the fourth process of bonding the tempered glass film unit, the anti-spattering film unit, and the functional thin layer film unit produced from the first, second, and third steps, respectively.

According to the invention preferably, the said second step is characterized by step of blending the said optical adhesive with antimicrobial before applying on PET film in the said second step.

According to the invention preferably, the said optical adhesive is characterized by acrylic or silicon or urethane series.

According to the invention preferably, the said second or third step can have the step of bonding another different sheet to the top side which an optical adhesive is applied on

### Advantageous Effects

Protection film for a display according to the invention comprises tempered glass film unit of thin layer wherein antifoulant coating layer is formed, anti-spattering film unit which is made of PET film with high transparency to prevent fragment to be spattered by sticking to the tempered glass film unit in case shock acts on tempered glass. By complete bond between each unit to prevent air space, space between layer such as bubble between structure layers can be prevented with thin layer type with high transparency maintained, and functional thin layer is prepared for the bottom surface of tempered glass film unit or anti-spattering film unit to have various function, and hazardous electromagnetic waves can be blocked and decrease of touch sensitivity can be prevented in electronic equipment with touch input means by providing especially function layer to block electromagnetic waves.

Also, detachability at multiple time facilitates cleaning, and antimicrobial included in optical adhesion layer can maintain antimicrobial persistence.

Next, manufacturing method of protection film for a display of the invention can improve manufacturing yield and increase productivity by producing main components of the invention such as tempered glass film unit and anti-spattering film unit or functional thin layer film unit in separate process and producing final protection film by combining each film unit finally.

### DESCRIPTION OF DRAWINGS

FIG. 1 is a drawing showing an example of conventional protection film for a display.

FIG. 2 is a drawing showing cross-sectional structure of protection film for a display according to the invention.

FIG. 3 is a flow chart showing briefly manufacturing process of protection film for a display according to the invention.

FIG. 4 is a drawing explaining part of manufacturing process of protection film for a display according to the invention.

FIG. 5 is a drawing showing cross-sectional structure of protection film for a display according to another embodiment of the invention.

FIG. 6 is a flow chart showing manufacturing process of protection film for a display according to another embodiment of the invention.

### DESCRIPTION OF THE REFERENCE NUMERALS IN THE DRAWINGS

1: display 110: tempered glass film

111: anti-foulant coating layer

112: functional thin layer 120: anti-spattering layer

121: the first optical adhesive layer

122: the second optical adhesive layer

### BEST MODE

An embodiment of the invention is explained in details with attached drawings as the following.

Referring to FIG. 2, protection film(100) for a display according to desired embodiment of the invention includes tempered glass film(110) having antifoulant coating layer(111) and functional thin layer(112) on both surface respectively, and anti-spattering layer(120) prepared on the bottom surface of tempered glass film(110), and adhesion is done between functional thin layer(112) and anti-spattering layer(120) by the first optical adhesive layer, and the second optical adhesive layer is prepared on the bottom surface of anti-spattering layer(120) to be attached to surface of a display.

Tempered glass film(110) is obtained by tempering process of thinned glass, physical strengthening method or chemical strengthening method which is used for noticed glass strengthening method can be used in the invention.

Physical strengthening method is the way to strengthen the inner strength of glass by heating glass with thickness more than 5.0 mm to 550° C.˜700° C. and freezing fast, however strengthening method by heating to high temperature cannot be applied to thin layer glass with thickness less than 3.0 mm which has no temperature difference between surface layer and centered layer in glass, thus mainly chemical strengthening method is applied to thin layer glass with thickness less than 3.0 mm.

Chemical strengthening method is to strengthen glass by compressive stress to the surface of glass caused by substitution of sodium ions whose ionic radius is smaller with potassium ions whose ionic radius is larger by immersing thin layer glass in heating process furnace with potassium nitrate solution in 3 hours or more. Thus, by the invention physical strengthening method or chemical strengthening method can be applied according to the thickness of glass, however chemical strengthening method which is suitable for thinner layer glass can be preferably used.

Antifoulant coating layer(111) coats the one side of flat surface of tempered glass film(110), and prevents pollution of surface with pollutants by coating the top surface of tempered glass film(110). This antifoulant coating layer can be provided by coating layer comprising AF(anti-finger) coating, AS(anti-scratch) coating or AC(anti-corrosion) coating, or coating layer comprising other functional mixture.

Functional thin layer(112) is prepared on the bottom surface of tempered glass film(110), can add various functionality. For example, conductive metal thin layer as functional thin layer can be used to block hazardous electromagnetic waves, and it is desired to be formed with thickness less than dozens of nano meter to some micro meter. This is for preventing air bubble around boundary during adhesion process which can occur by the level difference as much as thin layer between thin layer forming area and area without thin layer, and thin layer can be formed as thin as possible or conductive metal thin layer can be formed in some area of tempered glass film(110) as long as electromagnetic blocking function, transparency, and color implementation are not damaged.

Also, in the present the color of thin layer can be varied by metallic material for function blocking electromagnetic waves, and protection film with various color unlike transparent protection film can be provided, and can be implemented as long as function blocking electromagnetic waves is not damaged.

Functional thin layer with function blocking electromagnetic waves can be provided by well-known various method, for example, metallic material adhesion, or inosculating metallic film. Preferably, metallic thin layer is formed by sputtering process in order to form thinner metal thin layer. Electromagnetic wave blocking layer can adjust its thickness, or can be implemented using non-metallic compound like SiO2, or can be implemented only for some part of electronic equipment avoiding touch sensing area.

Meanwhile, for another example of functional thin layer, it can be used as printing layer which can present various type of pattern or figure on the part of flat surface. Functional thin layer functioning as printing layer is prepared transparent or opaque and give a good look by presenting printing figure depending on power of a display.

Anti-spattering layer(120) is bonded to the bottom surface of tempered glass film(110), specifically the bottom surface of functional thin layer(112) by optical adhesive, and has function which prevents pieces or fragments from being spattered in case tempered glass film(110) is broken by shock placed on a display(1).

For this anti-spattering layer(120), PC(polycarbonate) or PET(polyethylene terephthalate) film which is with superior mechanical strength and high transparency can be provided, preferably PET with high transparency can be used.

The first optical adhesive(121) is for attaching anti-spattering layer(120) to the bottom surface of tempered glass film(110), specifically the bottom surface of electromagnetic wave blocking layer(112), and optically transparent adhesive can be provided. Such optical adhesive layer is prepared between tempered glass film unit and anti-spattering layer, and complete adhesion is done to prevent air space, air bubble doesn't occur between film.

The first optical adhesive layer can be provided by acrylic or silicon-series adhesive, preferably by adhesive which is mainly made of 22 weight % acrylic coplymer and 42-51 weight % ethyl acetate.

It is desirable to maintain transparency of the first optical adhesive layer more than 80-90%, and implement thickness less than 30 micro meter.

The second optical adhesive layer(122) is prepared on the bottom surface of anti-spattering layer(120) to be attachable to flat surface of a display(1), and can be provided by optically transparent adhesive.

The second optical adhesive layer can be provided by silicon or urethane-series adhesive, preferably by adhesive which is mainly made of 30-60 weight % dimethyl siloxane, 20-30 weight % dimethyl-vinyl.

The second optical adhesive is characterized by no-air bubbling, and persistence of more than 80% adhesiveness for repeated multiple usage, and implementation with thickness less than 50 micro meter is desirable.

Especially, in the invention, it is desirable for the first optical adhesive(121) or the second optical adhesive(122) to include antimicrobial, preferably desirable for antimicrobial to be included in the first optical adhesive(121). While in the invention the second optical adhesive layer(122) can be attachable repeatedly to surface of a display, it is desirable for the first optical adhesive layer(121) to have bigger adhesiveness than the second optical adhesive layer to do anti-spattering role by combining functional thin layer(112) and anti-spattering layer(120).

Well-known antibacterial substance can be uses as antimicrobial, preferably antibacterial substance which is made of mainly phosphorous pentoxide(P205) and aluminum oxide(Al203) can be used as antimicrobial.

For antibacterial function, the top of protection film can be coated with antimicrobial, but in general the touch panel surface of toch panel device wherein touch operation is possible among electronic devices is contacted very often by user, thus antimicrobial which coated the top of protection film will be exfoliated or depleted, and the function can last for months at most, thus cannot meet some years of the least average life of electronic device.

Therefore, in the invention the first optical adhesive layer is prepared between tempered glass film and anti-spattering layer and mixed with antimicrobial to be provided, and antimicrobial persistence can be extended high and also excellent antimicrobial function can be expected in even the furrow of boundary surface on the edge of display surface wherein mildew or harmful bacteria is breeding actively.

Also, protection film according to the invention can be detachable and re-attachable multiple time repeatedly to display surface, protection film can be separated from a display and reused after cleaning itself

Protection film with such a configuration as above for a display in the invention can be manufactured by sequential process, however it is desirable to be manufactured by the process combining each film unit manufactured from tempered glass film unit manufacturing process and anti-spattering film unit manufacturing process separately.

Regarding manufacturing protection film in the invention, tempered glass film unit manufacturing process and anti-spattering film unit manufacturing process are very different from each other, thus manufacturing by sequential and overall process will worse profitability due to excessive investment for facilities and decrease of productivity and yield.

Therefore, protection film manufacturing method in the invention is characterized by manufacturing by combining finally each film unit manufactured separately.

Referring to FIG. 3 specifically, manufacturing method of protection film for a display in the invention includes the first process(S10) wherein the one side of flat surface of tempered glass of thin layer is coated with antifoulant coating layer, and thin layer having functionality on the other side of flat surface is formed and tempered glass film unit is produced; the second process(S20) wherein the both surface of PET film with high transparency is coated with optical adhesive respectively by the process which is separate from the first process, and anti-spattering film unit is produced ;and the third process(S30) wherein tempered glass film unit and anti-spattering film unit produced from the first process and the second process are combined.

As aforementioned, the first process(S10) is tempered glass film unit manufacturing process comprising process (S 11) processing glass into thin layer type of tempered glass film, process (S12) coating the one side of processed tempered glass film with antifoulant coating layer (S13), and produces tempered glass film unit.

The second process(S20) is the process manufacturing anti-spattering film unit, which includes the process(S22) coating the both sides of highly transparent PET film material with adhesive, and firing(heating) process and aging process after adhesive coating, and produces anti-spattering film unit.

On the other hand, as described the first optical adhesive can include antimicrobial, the process(S21) mixing antimicrobial into optical adhesive can be added before coating PET film material with adhesive.

Regarding manufacturing method in the invention, silicon or urethane series is desirable to be used as optical adhesive.

Also, optical adhesive can coat separately the (top) surface attaching to tempered glass film unit and the (bottom) surface attaching to the surface of a display with two different (the first and the second) optical adhesive, and antimicrobial is desirable to be mixed with (the first)optical adhesive which coats the (top) surface attaching to tempered glass film unit.

Tempered glass film unit manufactured by the first process(S10) and anti-spattering film unit manufactured from the second process(S20) are finally adhered to each other to produce protection film by combination process, final product is completed through post process(S40) of regular size cutting and inspection.

Meanwhile, the second process(S20) is characterized by additionally attaching a separate sheet to the top of adhesive which coats anti-spattering film unit

Referring to FIG. 4, tempered glass film unit(110a) manufactured by the first process and anti-spattering film unit(120a) manufactured by the second process produce final product by combination process, however, in the invention the first process and the second process have different process line for manufacturing, thus it is desirable to prevent anti-spattering film unit(120a) from pollution by foreign substance after manufacturing until combination process combining with tempered glass film unit(110a).

Thus, in the second process it is desirable different sheet(131)(132) is attached to the top of optical adhesive after anti-spattering film unit(120a) is manufactured, and afterwards in combination process a different sheet(131) is removed and combining with tempered glass film unit(110a) is done.

Meanwhile, the lower different sheet(132) is removed before when protection film in the invention is attached to the surface of a display.

Next, protection film for a display according to another embodiment of the invention, comprises tempered glass film(210) coated with antifoulant coating layer(211) on the one side of its flat surface; optically transparent anti-spattering layer(220) attached to the bottom side of the said tempered glass film by the first optical adhesive(221); functional thin layer(230) attached to the bottom side of the said anti-spattering layer(220) by the second optical adhesive layer(231); the third optical adhesive layer(232) attachable to the surface of a display by attaching to the bottom surface of the said anti-spattering layer(230).

Each component comprising protection film for a display is practically identical to the previous embodiment, and is characterized by attaching functional thin layer to the bottom side of anti-spattering layer(220) instead of tempered glass film by the second optical adhesive. Thus, what is overlapped are to be dropped and the difference is explained in priority.

Functional thin layer(230) is prepared beneath the bottom side of anti-spattering layer(220), thus air bubble doesn't occur in the surface of a display from the bottom side of functional thin layer(230), and adhesiveness is maintained for repeated multiple usage, and the third optical adhesive layer(232) optically transparent is prepared for visual light region.

The third optical adhesive layer(232) is provided by silicon or urethane series adhesive.

Especially, incase conductive metal layer is used as functional thin layer(230) to block hazardous electromagnetic waves, dozens μm thick metal film can be inosculated and used as long as the level difference between combined films doesn't occur.

On the other hand, functional thin layer in the invention can be used as printing layer which can present various type of pattern or figure on the part of flat surface. This functional thin layer functioning as printing layer is prepared transparent or opaque and can present printing figure depending on power of a display.

Referring to FIG. 6, manufacturing method of protection film for a display according to another embodiment of the invention includes the first process(S50) wherein the one side of flat surface of tempered glass of thin layer is coated with antifoulant coating layer; the second process(S60) wherein the both surface of PET film with high transparency is coated with optical adhesive respectively by the process which is separate from the first process, and anti-spattering film unit is produced; and the third process(S70) wherein by the process functional thin layer is coated with optically transparent adhesive and functional thin layer is produced separately from the first and second process(S50)(S60); the fourth process(S80)combining tempered glass film unit, anti-spattering film unit, and functional thin film unit manufactured from the first, second, and third process (S50)(S60)(S70).

The first process(S50) is the process manufacturing tempered glass film unit, in previous embodiment(referring to FIG. 3) it can be implemented the same except for the process forming functional thin layer on the one side of tempered glass film by the process(S51) processing glass into thin layer type of tempered glass film and the process coating tempered glass film with antifoulant coating layer(S52).

Also, the second process(S60) is anti-spattering film manufacturing process(S62) that includes process coating highly transparent PET film material with adhesive, and firing(heating) process and aging process(S63) to produce anti-spattering unit after adhesive coating process.

Meanwhile, as explained antimicrobial can be included in adhesive, process(S61) mixing antimicrobial into adhesive can be added before coating PET film material with adhesive. For optical adhesive, acrylic or silicon-series adhesive which is transparent for visual light region is used.

The third process(S70) is for coating functional thin layer with optical adhesive and producing functional thin layer film unit, and produces functional thin layer film unit by coating functional film material with adhesive.

For example, functional film material can be dozens of μm thick conductive metal film in case functional film material has function blocking hazardous electromagnetic waves. The both sides of such metal film are coated with adhesive.

Meanwhile, for bottom surface of functional thin layer, silicon or urethane series adhesive can be provided in order to enable it to repeatedly detach and re-attach to a display surface.

On the other hand, for the top surface of functional thin layer, adhesive with strong adhesion such as acrylic or silicon series optical adhesive can be used to make strong attachment to anti-spattering film.

In the second process(S60) or the third process(S70), process(S61)(S71) mixing antimicrobial into adhesive before coating can be added, desirably antimicrobial mixing process can be added to the second process.

Meanwhile, the second process(S60) or the third process(S70) in the invention different sheet can additionally attached to the top side coated with optical adhesive. Different sheet prepared like this can prevent the surface of optical adhesive from pollution by foreign substance before the process combining each film unit, different sheet is removed in the process combining each film unit, and each film unit is combined to complete final product.

The present invention described above is not limited only by foregoing embodiment and accompanying drawings, and it will be understood by those of ordinary skill in the art that various substitutions, modifications and changes may be made without departing from the spirit and scope of the present invention.

1. A protection film for a display comprising:
a tempered glass film with an antifouling coating layer coated on one side of it and an functional thin film layer coated on the other side of it;
an optically transparent anti-spattering layer bonded to one side of the said functional thin layer with a first optical adhesive layer therebetween; and
a second optical adhesive layer by which the anti-spattering layer is bonded to the display surface.

2. A protection film for a display comprising:
a tempered glass film with an antifouling coating layer coated on one side of it;
an optically transparent anti-spattering layer bonded to the other side of the said tempered glass film with the first optical adhesive layer therebetween;
a functional thin layer bonded to one side of the said anti-spattering layer with the second optical adhesive layer therebetween; and
a third optical adhesive layer by which the other side of the anti-spattering layer is bonded to the display surface.

3. The protection film for a display of claim 1, wherein the first optical adhesive or the second optical adhesive is silicon or urethane series.

4. The protection film for a display of claim 1, wherein the second optical adhesive layer is silicon or urethane series.

5. The protection film for a display of claim 2, wherein the first optical adhesive layer or the second optical adhesive layer also includes antimicrobial.

6. The protection film for a display of claim 1, wherein the said anti-spattering layer is highly transparent PET film.

7. The protection film for a display of claim 1, wherein the said functional thin layer is conductive metal layer to block electromagnetic waves.

8. A method for manufacturing a protection film for a display, comprising:
a first step of manufacturing a tempered glass film unit by coating an antifouling coating layer one side of the tempered glass and forming a functional thin film layer on the other side of it;
a second step of applying optically transparent optical adhesive on both sides of a highly transparent PET film to make an anti-spattering film unit;
a third step of bonding the tempered glass film unit and the anti-spattering film unit produced from the first and second steps, respectively.

9. A method of manufacturing a protection film for a display comprising:
a first step of manufacturing a tempered glass film unit by coating an antifouling coating layer one side of the tempered glass;
a second step of applying optically transparent optical adhesive on both sides of a highly transparent PET film to make an anti-spattering film unit;
a third step of applying optically transparent optical adhesive on a functional thin layer to make a functional thin layer film unit; and
a fourth process of bonding the tempered glass film unit, the anti-spattering film unit, and the functional thin layer film unit produced from the first, second, and third steps, respectively.

10. The method of manufacturing a protection film for a display of claim 8, wherein the said optical adhesive is blended with antimicrobial before applying on the PET film in the said second step.

11. The method of manufacturing a protection film for a display of claim 8, wherein the said optical adhesive is silicon or urethane series.

12. The method of manufacturing a protection film for a display of claim 8, wherein the said second or third step have the step of bonding another different sheet to the top side which an optical adhesive is applied on.

13. The protection film for a display of claim 2, wherein the first optical adhesive or the second optical adhesive is silicon or urethane series.

14. The protection film for a display of claim 2, wherein the said anti-spattering layer is highly transparent PET film.

15. The protection film for a display of claim 2, wherein the said functional thin layer is conductive metal layer to block electromagnetic waves.

16. The method of manufacturing a protection film for a display of claim 9, wherein the said optical adhesive is blended with antimicrobial before applying on the PET film in the said second step.

17. The method of manufacturing a protection film for a display of claim 9, wherein the said optical adhesive is silicon or urethane series.

18. The method of manufacturing a protection film for a display of claim 9, wherein the said second or third step have the step of bonding another different sheet to the top side which an optical adhesive is applied on.
